(19) United States
(12) Patent Application Publication
(10) Pub. No.: US 2025/0368150 A1
(43) Pub. Date: Dec. 4, 2025

(54) SYSTEM FOR IDENTIFYING ELECTRONIC MODULE LOCATION WITHIN A VEHICLE

(71) Applicant: HELLA GMBH & CO. KGAA, Lippstadt (DE)

(72) Inventor: Salim Hanna, Northville Twp., MI (US)

(21) Appl. No.: 18/676,749

(22) Filed: May 29, 2024

(51) Int. Cl. B60R 16/023; G01P 15/16

(52) U.S. Cl. CPC B60R 16/0232; G01P 15/165

(57) ABSTRACT

An electronic module to automatically determine is position within a vehicle is provided. The electronic module includes a plurality of input connectors comprising an I/O interface for a vehicle wiring harness, the electronic module also including an accelerometer to provide an additional datum point. Based on the accelerometer output, the electronic module can determine if it is facing inward, toward the center of the vehicle, or facing laterally outward. In this respect, the electronic module can convert an n-bit I/O interface into an n+1 bit I/O interface to thereby double the number of locations that are detectable by the electronic module. For wiring harnesses limited to two physical pins, for example, only four locations are normally detectable, but with the additional accelerometer input, eight locations are detectable. As a result, the same electronic module can be used for up to eight locations, thereby simplifying installation.

### FIELD OF THE INVENTION

The present invention relates to systems for automatically identifying the location of an electronic module within a vehicle.

### BACKGROUND OF THE INVENTION

Modern vehicles include advanced electronics to monitor and control a wide range of vehicle systems. Often referred to as electronic control modules (ECMs), these modules are optimized for specific tasks and are interconnected throughout the vehicle to manage its operation. For example, body control modules (BCMs) are one type of ECM that control various functions related to the vehicle's body, such as interior and exterior lighting, door locks, power windows, and climate control. These modules communicate with each other and with external sensors using standardized communication protocols, such as the Controller Area Network (CAN).

More recently, vehicle-mounted ECMs include an I/O interface having dedicated pins for identifying the location of the ECM within the vehicle. For an I/O interface having two dedicated pins for binary inputs, the I/O interface can be connected to one of four vehicle wiring harnesses. Each I/O interface includes a 4-bit input (or for n-number of pins, a 2ⁿ bit input), as each pin is either grounded or open. In this fashion, the ECM can recognize its position at one of four locations within the vehicle. The installation of the ECM is automatically determined at the ECM and communicated to a central controller, thereby avoiding the need to manufacture a dedicated ECM for each available installation location within a vehicle.

However, there remains a continued need for an improved module that is adapted to automatically determine its location within a vehicle. In particular, there remains a continued need for an improved module that can determine its location across a broader number of locations despite being limited by the number of input pins in the corresponding vehicle wiring harness.

### SUMMARY OF THE INVENTION

An electronic module to automatically determine its position within a vehicle is provided. The electronic module includes a plurality of input connectors comprising an I/O interface, the electronic module also including an internal sensor, for example an accelerometer, to provide an additional datum point for the I/O interface. Based on the output of the internal sensor, the electronic module can determine its physical orientation. With this additional datum point, which (like the input connectors) is also an I/O input, the electronic module can convert an n-bit I/O interface into an n+1 bit I/O interface to thereby double the number of locations that are detectable by the electronic module. For wiring harnesses limited to two position pins, for example, only four locations are normally detectable, but with an additional accelerometer input, eight locations are detectable. As a result, the same electronic module can be used with twice the number of locations, thereby simplifying installation.

In one embodiment, the electronic module includes a pin connector, an alignment aid, an internal sensor, and a processor. The pin connector includes a plurality of connector pins (or sockets). Among the plurality of connector pins are n-number of position pins that are configured to receive an n-bit position signal from the vehicle. The alignment aid can include any physical feature to ensure that the electronic module is able to be installed in only one physical orientation at a given location in a vehicle, including a keyway, a tab, a projection, or a notch. The internal sensor is configured to measure acceleration along a plurality of sensing axes that are fixed in relation to the electronic module, for example the X, Y, and Z axes, such that the processor can recognize its physical orientation, e.g., upright versus inverted, forward facing versus rearward facing, etc. Lastly, the processor is configured to determine an installation location of the electronic module based on the n-bit position signal and its physical orientation. For example, the processor can be configured to recognize up to 2ⁿ⁺¹ installation locations of the electronic module, the processor operating differently among at least two possible installation locations within the vehicle.

In some embodiments the internal sensor includes an accelerometer, for example a microelectromechanical system (MEMS) accelerometer, while in other embodiments the internal sensor includes a gyroscopic sensor. The electronic module can comprise essentially any module of a larger system, including for example vehicle lighting systems, collision avoidance systems (including radar and/or lidar), blind-spot monitoring systems, emergency braking systems, and airbag control systems. The electronic module operates differently depending on its location within the vehicle, such that the processor executes a first set of computer readable instructions if installed at a first location of the vehicle, and the processor executes a second set of computer readable instructions if installed at a second location within the vehicle, the second location being different from the first location.

In another embodiment, a method of operation is provided. The method includes receiving, at a pin connector, a position signal indicative of an installation location of the electronic module. The method further includes determining a physical orientation of the electronic module based upon the output of an internal sensor, optionally an accelerometer or a gyroscopic sensor. The method then includes determining the installation location of the electronic module based upon the position signal and the output of the internal sensor. For example, for an n-bit position signal, the added orientation data of the electronic module allows for up to 2ⁿ⁺¹ detectable installation locations. In this regard, a multi-functional electronic module can be installed at a plurality of locations within a vehicle, and a vehicle-mounted central computer configures corresponding functions of the electronic module according to the installed positional information. The electronic module can also include an alignment aid, such that the electronic module can only be installed with a first physical orientation at a first physical location and a second physical orientation at a second physical location, the second physical orientation being different from the first physical orientation (e.g., upright versus inverted, or forward facing versus rearward facing).

The electronic module contains instructions that, when executed by the processor, cause the processor to perform one or more functions related to a vehicle's operation. The one or more functions can include, by example, sensor data calibration, sensor data fusion, object detection, decision making, and/or control of vehicle functions, e.g., exterior lighting, braking, seating, and/or instrumentation. The electronic module can be installed without considering the position of the finished vehicle, and a central computer can then configure the electronic module according to the installed positional information, so that a universal and/or multi-functional electronic module can operate as appropriate pursuant to its position within the vehicle.

These and other features and advantages of the present invention will become apparent from the following description of the invention, when viewed in accordance with the accompanying drawings and the appended claims. It will be appreciated that any of the preferred and/or optional features of the invention may be incorporated alone, or in appropriate combination, within embodiments of the invention, while still falling within the scope of claim 1, even if such combinations are not explicitly claimed in the appended claims.

### BRIEF DESCRIPTION OF THE DRAWINGS

FIG. 1 is a block diagram of an electronic module having an internal sensor for determining the orientation of the electronic module within a vehicle.

FIG. 2 includes a plan view of an electronic module depicted in accordance with an exemplary embodiment.

FIG. 3 illustrates the electronic module of FIG. 2 in an upright orientation.

FIG. 4 illustrates the electronic module of FIG. 2 in an inverted orientation.

FIG. 5 illustrates the electronic module of FIG. 1 at six potential locations within a vehicle in accordance with an exemplary embodiment.

FIG. 6 is a logic table for determining the location of the electronic module depicted in FIG. 1.

### DETAILED DESCRIPTION OF THE PRESENT EMBODIMENTS

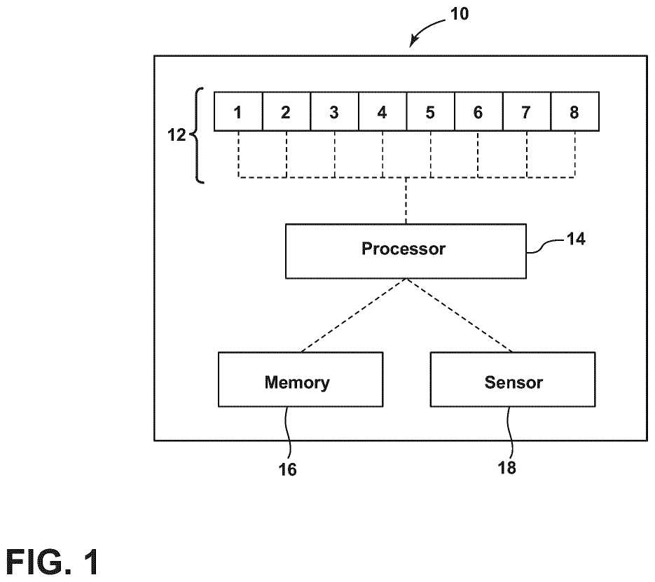

Referring to FIG. 1, a block diagram of an electronic module is illustrated and generally designated 10. As used herein, an electronic module 10 is any self-contained control unit that performs one or more functions as part of a larger system. By non-limiting example, the electronic module 10 can comprise a body control module (BCM) for controlling various electrical systems within the vehicle body, such as lighting, power windows, door locks, and/or climate control. Also by non-limiting example, the electronic module 10 can comprise part of an advanced driver assistance system (ADAS), such as collision avoidance systems, blind-spot monitoring systems, and emergency braking systems. The ADAS can include, for example, multiple electronic modules 10 for managing the operation of radar or lidar sensors, including their activation, calibration, and data processing. In this context, the electronic module 10 can interpret the output of one or more external sensors to detect objects, assess their distance, relative speed, and trajectory, and communicate this information to a centralized control unit. The electronic module 10 is not limited to any one application, however, and can include other applications such as antilock braking, engine control, transmission control, airbag control, and instrument cluster control, and still other applications whether now known or hereinafter developed.

Referring again to FIG. 1, the electronic module 10 includes a pin connector 12, a processor 14, an internal memory 16, and an internal sensor 18. The pin connector 12 includes a plurality of pins (or sockets) that make electrical contact with a corresponding number of sockets (or pins) of another device, for example a vehicle wiring harness. In the illustrated embodiment, the pin connector 12 includes a single row of eight pins having a predetermined pitch (spacing). Other embodiments can include a different number of pins and/or one or more additional rows of pins. By non-limiting example, the pin connector 12 can include a JST connector, an OBD-II connector, or a Deutsch connector. Still other pin connectors can be used in other embodiments.

A subset of the pins can be configured to receive identifying information from the corresponding wiring harness. In the illustrated example, pins 7 and 8 can be either grounded or open (0,1). Pins 7 and 8 receive four possible bit combinations (0/0, 0/1, 1/1, 1/0), such that the electronic module 10 can automatically recognize one of four installation locations. The remaining pins (e.g., pins 1 through 6) are power connectors or data connectors according to the applicable pinout, and these pins are not used by the electronic unit 10 to determine its location.

The pin connector 12 is electrically connected to the processor 14 and comprises an input/output interface for electronic module 10. The processor 14, in turn, is electrically coupled to the memory 16. The memory 16 contains instructions that, when executed by the processor 14, cause the processor 14 to perform one or more functions related to a vehicle's operation. The one or more functions can include, by non-limiting example, sensor data calibration, sensor data fusion, object detection, decision making, and/or control of vehicle functions, e.g., exterior lighting, braking, seating, and/or instrumentation. The processor 14 can include for example a microcontroller, a digital signal processor (DSP), or a system-on-chip (SoC) processor. In other embodiments, the processor 14 comprises an application-specific integrate circuit (ASIC) for the control of one or more vehicle functions.

As noted above, the electronic module 10 includes an internal sensor 18 to determine its orientation. The internal sensor 18 can include an accelerometer which measures the acceleration experienced by the electronic module 10 along multiple orthogonal axes. The internal sensor 18 can also or alternatively include a gyroscopic sensor, which can provide more precise measurements of angular orientation. By non-limiting example, the internal sensor 18 can comprise a microelectromechanical system (MEMS) accelerometer. MEMS accelerometers are found in airbag deployment systems, stability control systems, and consumer electronics, to name but a few applications, and they benefit from low power consumption and high sensitivity. The MEMS accelerometer (or other internal sensor) provides an electrical output to the processor 14, the electrical output being indicative of the orientation of the electronic module 10, such that the processor 14 can monitor or track its orientation along three spatial axes: X (horizontal), Y (vertical), and Z (depth). Particularly where the electronic module 10 includes an alignment aid (as discussed below), the processor 14 can then determine the angular orientation of the electronic module 10, and with this information, its relative location within a vehicle.

To enhance the number of locations that are detectable by the electronic module 10, the internal sensor 18 provides an electrical signal to the processor 14 indicative of the physical orientation of the electronic module 10. For example, the internal sensor 18 can provide an analog or digital output to the processor 14 indicative of the acceleration forces acting on the electronic module 10 along its sensing axes. For example, FIG. 3 illustrates an electronic module 10 having a negative acceleration in the Z-axis, such that the electronic module 10 is in a first (upright) orientation. Also by example, FIG. 4 illustrates an electronic module 10 having a positive acceleration in the Z-axis, such that the electronic module 10 is in a second (inverted) orientation. In these examples, the sensing axes are fixed in relation to the electronics module 10, such that that the X-axis is aligned with a first side edge 20 (from left to right), the Y-axis is aligned with a second side edge 22 (from bottom to top), and the Z-axis is orthogonal to both of the X-axis and the Y-axis along the shortened side edge 24. Alternatively, the internal sensor 18 can provide a binary output to the processor 14 to indicate one of two possible installations, e.g., upright v. inverted, left-facing v. right-facing, or forward-facing v. rearward facing. When used in combination with an alignment aid, as discussed below, the processor 14 can automatically determine the location of the electronic module 10 within the vehicle.

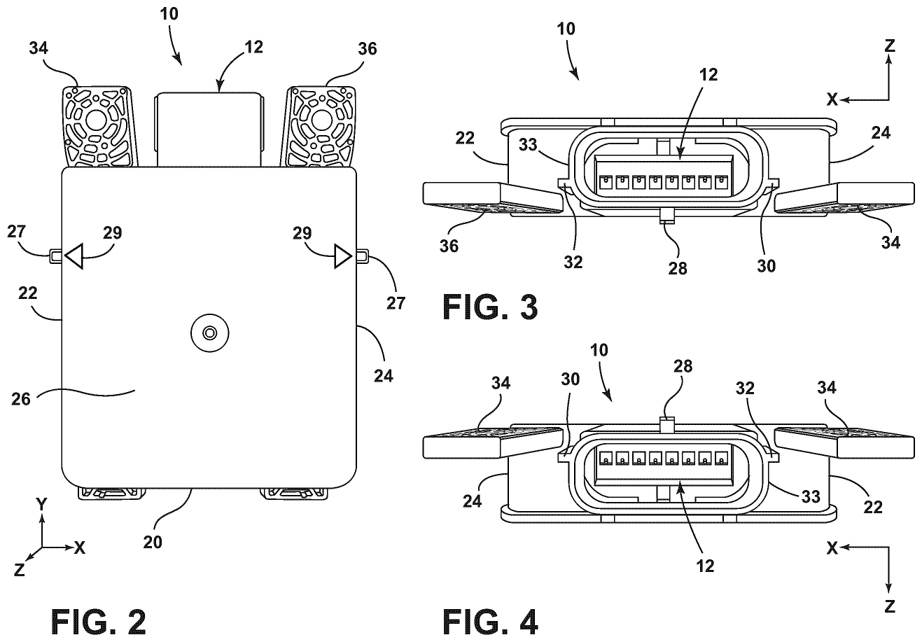

In particular, the electronic module 10 includes a housing 26 having one or more physical alignment aids 27, such that the electronic module 10 can be installed at each particular vehicular location with only a single physical orientation. The alignment aid 27 can be any physical constraint that prevents incorrect assembly of the electronic module 10 at a given installation location, including for example keyways, tabs, projections, ridges or notches. As shown in FIG. 2 for example, the housing 26 includes two tabs 27 that are aligned with notches in a corresponding mounting receptacle (not shown), such that the housing 26 can be installed in only a single physical orientation at each installation location within the vehicle. Physical alignment aids 27 are not strictly required however, as the housing 26 can include one or more visual alignment aids 29, for example arrows, labels, or other printed indicia, to promote installation of the electronic module 10 in a given physical orientation at each installation location.

As also shown in FIGS. 3-4, the housing 26 is configured for the appropriate wiring harness. In the illustrated embodiment, the housing 26 includes three projections 28, 30, 32 that are asymmetrically disposed about the pin connector collar 33. The projections 28, 30, 32 ensure that the connector pins 12 are paired within the appropriate electrical connectors when the electronic module 10 and the wiring harness (not shown) are connected. The housing 26 also includes first and second mounting bracket 34, 36 on either side of the pin connector 12. The mounting brackets 34, 36 include a fastener opening for securing the housing 26 to a suitable mounting receptable with aligned fastener openings.

In another embodiment, the electronic module 10 is rotatable among a plurality of physical orientations, with each physical orientation being detectable by the internal sensor 18. The internal processor 14 executes a corresponding instruction set, such that the electronic module 10 operates differently depending upon its physical orientation at the given installation location. Merely by example, the internal processor 14 executes a first instruction set when in the one o'clock position, a second instruction set when in the two o'clock position, and so on, with the first instruction set being different from the second instruction set. The instruction sets can include, for example, sensor data calibration, sensor data fusion, object detection, decision making, and/or control of vehicle functions. In this respect, a multifunctional, universal electronic module 10 can be used at a single installation location, which is made possible by the internal sensor 18.

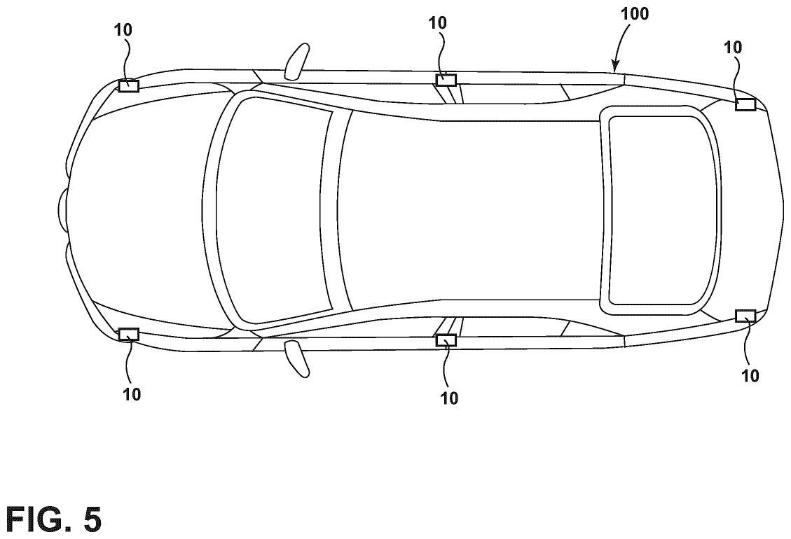

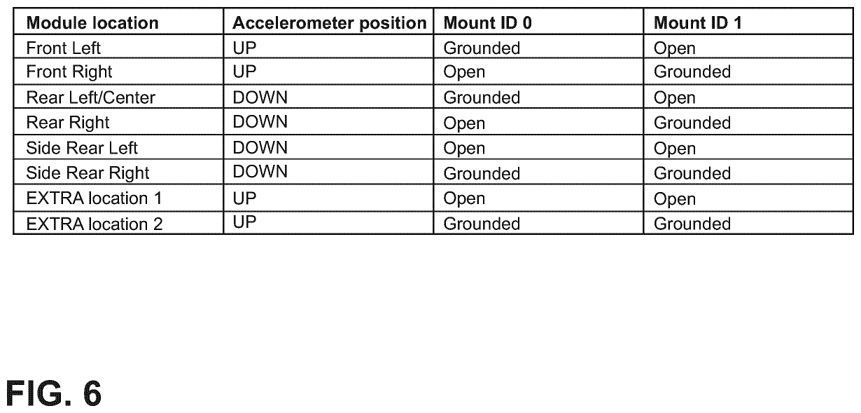

Referring now to FIGS. 5 and 6, a further embodiment is illustrated. In this example, the electronic module 10 comprises a universal radar module for installation at one of six potential locations within the vehicle 100. The electronic module 10 includes two dedicated position pins (Mount ID 0 and Mount ID 1) and an internal accelerometer. For an electronic module with n-number of position pins, the accelerometer increases the number of detectable positions from 2ⁿ to 2ⁿ⁺¹ number. For two position pins (Mount ID 0 and Mount ID 1), the number of detectable positions increases from 4 to 8. As shown in FIG. 6, installation of the electronic module 10 in an upright orientation (as shown at FIG. 3) indicates to the internal processor 14 that the electronic module 10 is located at the front of the vehicle 100, as the alignment aids 27 (or visual installation markers 29) prevent installation of the electronic module 10 in the inverted position at the front of the vehicle 100. Installation of the electronic module 10 in an inverted position (as shown in FIG. 4) indicates to the internal processor 14 that the electronic module 10 is located at the center of the vehicle 100 or the rear of the vehicle 100, as the alignment aids 27 prevent installation of the electronic module 10 in the upright position at the center or rear of the vehicle 100. The alignment aids 27 (or visual installation markers 29) ensure that the electronic module 10 can only be installed in an upright orientation at the front of the vehicle and in an inverted location at the middle and rear of the vehicle. The binary position signals at the position pins indicate to the internal processor 14 the left/right and center/rear position of each electronic module 10. Two unused locations are also available in this example.

To reiterate, the present invention provides an electronic module 10 configured to automatically determine its position within a vehicle 100. The electronic module 10 includes a plurality of inputs and an internal sensor 18 to provide an additional datum point. Based on the sensor output, the electronic module 10 can determine its orientation, and with this information, double the number of detectable installation locations. In other words, the sensor 18 can convert an n-bit I/O interface into an n+1 bit I/O interface and thereby double the number of locations that are detectable by the electronic module 10. For wiring harnesses limited to two physical pins, for example, only four locations are normally detectable, but with the additional accelerometer input, eight locations are detectable. As a result, the same electronic module 10 can be used for up to eight locations, thereby simplifying its design and installation. The electronic module 10 can be installed without considering the position of the finished vehicle, and a vehicle-mounted central computer can then configure corresponding functions of the electronic module 10 according to the installed positional information, so that a universal electronic module can operate as appropriate pursuant to its position within the vehicle 100.

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An electronic module comprising:
a pin connector including a plurality of connector pins, wherein a subset of the plurality of connector pins includes n-number of position pins adapted to receive a position signal, the position signal being indicative of a location of the electronic module within the vehicle;
an internal sensor configured to measure acceleration along a plurality of sensing axes, the internal sensor providing an output; and
a processor in electrical communication with the pin connector and the internal sensor, wherein the processor is configured to determine an installation location of the electronic module based on the position signal in combination with the output of the internal sensor, the processor operating differently among at least two of a plurality of installation locations within a vehicle.

2. The electronic module of claim 1, wherein:
the position signal comprises an n-bit binary signal indicative of the installation location of the electronic module; and
the processor is configured to recognize up to 2ⁿ⁺¹ installation locations of the electronic module within the vehicle.

3. The electronic module of claim 1, wherein the internal sensor comprises at least one of an accelerometer and a gyroscopic sensor.

4. The electronic module of claim 1, wherein the internal sensor comprises a micro-electromechanical system (MEMS) accelerometer.

5. The electronic module of claim 1, wherein the plurality of sensing axes comprises three orthogonal axes aligned with three corresponding side surfaces of the outer housing.

6. The electronic module of claim 1, further including an outer housing including at least one alignment aid that prevents incorrect assembly of the electronic module among the plurality of installation locations within a vehicle.

7. The electronic module of claim 6, wherein the alignment aid includes a keyway, a tab, a projection, a ridge, or a notch.

8. The electronic module of claim 1, wherein the electronic module comprises a control module for vehicle lighting, collision avoidance, blind-spot monitoring, emergency braking, power windows, door locks, climate control, airbag control, or instrument cluster control.

9. The electronic module of claim 1, further including machine readable memory with instructions that, when executed by the processor, cause the processor to operate differently among at least two of the plurality of installation locations.

10. The electronic module of claim 1, wherein the pin connector comprises a JST connector, an OBD-II connector, or a Deutsch connector.

11. A method comprising:
providing an electronic module including a pin connector and an internal sensor, the electronic module being configured for a plurality of installation locations within a vehicle;
receiving, at the pin connector, a position signal indicative of an installation location of electronic module within a vehicle;
determining a physical orientation of the electronic module based upon the output of the internal sensor; and
determining the installation location of the electronic module based on the position signal in combination with the output of the internal sensor, the electronic module operating differently among at least two of the plurality of installation locations.

12. The method of claim 11, wherein:
the position signal comprises an n-bit binary signal; and
the plurality of installation locations includes up to 2ⁿ⁺¹ installation locations.

13. The method of claim 11, wherein the internal sensor comprises at least one of an accelerometer and a gyroscopic sensor.

14. The method of claim 11, wherein the internal sensor comprises a micro-electromechanical system (MEMS) accelerometer.

15. The method of claim 11, wherein the electronic module includes an alignment aid that prevents incorrect assembly of the electronic module among the plurality of installation locations.

16. The method of claim 15, wherein the alignment aid includes a keyway, a tab, a projection, a ridge, or a notch.

17. The method of claim 11, wherein:
the internal sensor is configured to measure acceleration along a plurality of sensing axes that are fixed in relation to the electronic module; and
the plurality of sensing axes comprise three orthogonal axes aligned with three exterior side surfaces of electronic module.

18. The method of claim 11, wherein the electronic module comprises a control module for vehicle lighting, collision avoidance, blind-spot monitoring, emergency braking, power windows, door locks, climate control, airbag control, or instrument cluster control.

19. The method of claim 11, wherein the electronic module includes machine readable memory with instructions that, when executed by a processor, cause the processor to operate differently among at least two of the plurality of installation locations.

20. The method of claim 11, wherein the pin connector comprises a JST connector, an OBD-II connector, or a Deutsch connector.
